(19) United States
(12) Patent Application Publication
(10) Pub. No.: US 2023/0193945 A1
(43) Pub. Date: Jun. 22, 2023

(54) BOLT ASSEMBLY

(71) Applicant: ROLLS-ROYCE DEUTSCHLAND LTD & CO KG, Blankenfelde-Mahlow (DE)

(72) Inventors: Robert W. HEETER, Noblesville, IN (US); Eric THURSTON, Indianapolis, IN (US); Jonathan M. RIVERS, Indianapolis, IN (US); Matthew J. KAPPES, Greenwood, IN (US)

(21) Appl. No.: 17/721,796

(22) Filed: Apr. 15, 2022

Related U.S. Application Data
(60) Provisional application No. 63/292,212, filed on Dec. 21, 2021.

(51) Int. Cl. F16B 43/00; F16B 33/00

(52) U.S. Cl. CPC F16B 43/00; F16B 33/00; F02C 7/00

(57) ABSTRACT

Aspects of the disclosure regard a bolt assembly which comprises a bolt extending in a longitudinal direction through a flange connection, the bolt comprising a first portion and a second portion, the first portion comprising a threaded section at a first side of the flange connection and the second portion comprising a head portion at a second side of the flange connection. The bolt assembly further comprises a nut screwed on the threaded section and a spacer arranged between the nut and the flange connection or between the head portion and the flange connection. The bolt is comprised of a titanium alloy.

This application claims priority to U.S. Provisional Patent Application 63/292,212 filed Dec. 21, 2021, the entirety of which is incorporated by reference herein.

The present disclosure relates to a bolt assembly that is suitable for implementing flange connections of a fan case of a gas turbine engine.

Gas turbine engines comprise a generally cylindrical fan case which encloses a fan driven by a core engine of the gas turbine engine. The fan case may be referred to a fan containment case as well. The fan case is a near cylindrical casing that surrounds the fan blades at the front of the engine. One main purpose of the fan case is to catch and contain a blade in the unlikely event of a part or whole blade becoming detached. This is known as a “Fan Blade Off” (FBO) event. The requirement is that no high-energy fragments should escape the containment system which is essential to prevent damage to other parts of the engine structure or to the fuselage of the aircraft.

A fan case is connected at its front end to an engine inlet. The connection is implemented as flange connection and typically referred to as A1 connection. The fan case further comprises an aft end at which it is connected to further structural elements of the gas turbine engine. This connection is also realized as a flange connection and referred to as A3 connection. Bolts are used to implement the flange connections.

The flange connections need to survive FBO events and its related loading. To this end, a high integrity of the bolts used to implement the A1 or A3 connection is required. Stretched bolts during FBO which no longer provide suitable clamping load at the flange connection and which could be problematic during windmill after an FBO should be avoided.

There is thus a desire to improve bolt assemblies in that the integrity of the bolts is maintained after an FBO event.

According to an aspect of the invention, a bolt assembly is provided, the bolt assembly comprising a bolt, a nut and a spacer. The bolt extends in a longitudinal direction through a flange connection, wherein the bolt comprises a first portion and a second portion, the first portion comprising a threaded section at a first side of the flange connection and the second portion comprising a head portion at a second side of the flange connection. The nut is screwed on the threaded section. The spacer is arranged between the nut and the flange connection or between the head and the flange connection. It is provided that the bolt is comprised of a titanium alloy.

Aspects of the invention are thus based on the idea to form the bolt from a titanium alloy. This leads both to an improved capability as well as a reduced weight of the bolt compared to prior art bolts typically consisting of steel or nickel-based high-temperature low creep superalloys. The capability is improved in that the elastic modulus of titanium alloys is relatively low. This is associated with the bolt being exposed to less load, wherein more load is being taken up by the flange. This also increases the reserve factor of the bolts while making better use of the flange connection.

The weight is reduced in that the density of titanium is roughly half of that of steel. Further, the number of bolts used to implement the flange connection may be reduced due to the improved integrity of the bolts. Also, the bolts may be formed smaller diameter and thus lighter. For example, combining fewer optimized bolts with nearly half the density as well as higher strength may provide significant weight savings for a Civil Small or Medium Engine.

In an embodiment, the bolt titanium alloy has a yield strength above 500 MPa and/or an elastic modulus smaller than 150 GPa. With elastic modulus Young's modulus is meant. In an embodiment, it is provided that the density is smaller than 5 g/cc and/or that the elongation at failure is larger than 15 percent (elongation at failure being a value that indicates the permanent elongation of the tensile specimen after break, relative to an initial gauge length).

In an embodiment, the spacer is also comprised of a titanium alloy, wherein a different titanium alloy may be utilized in the spacer. Using a titanium alloy spacer is associated with the advantages of a reduced spacer stiffness (due to a relatively low elastic modulus of titanium) and a reduced weight.

In an embodiment, the spacer titanium alloy has a larger elasticity than the bolt titanium alloy. This allows the spacer to compress more and spring back more if the bolt lengthens slightly.

In an embodiment, the spacer is comprised of a Ti-3Al-8V-6Cr-4Mo-4Zr titanium alloy. The common name of such alloy is Ti Beta-C. The alloy is an ASTM Grade 19 or 20 alloy and can be specified by AMS 4957 or AMS 4958. The yield strengths of Ti Beta-C is 1170 MPa and the elastic modulus is 107 GPa. Therefore, a spacer made of Ti Beta-C can compress well for a given load and shapes can be thinner for a given load before failing in yield. This leads to a “springier” spacer design. In combination with the bolt being comprised of a titanium alloy with less elasticity than the spacer, such spacer material brings about more spring action in the spacer and makes for a system of more robust bolts.

In a further embodiment, the spacer is shaped to have a lower stiffness in the longitudinal direction under compression compared to the stiffness of a strictly cylindrical shape. Stiffness is the extent to which an object resists deformation in response to an applied force. Stiffness is complementary to flexibility. According to this aspect, in increased flexibility of the spacer is provided for not by the material (which may further add though to the flexibility by its elasticity) but by the shape of the spacer. By having a reduced stiffness and increased flexibility, the spacer may compress more.

The spacer may have a plurality of shapes and forms to provide for a reduced stiffness. The spacer may comprise a conic shaped lateral surface. The spacer may comprise a conic through hole. The spacer may comprise a lateral surface shaped as a conic hourglass, a curved hourglass or a mirrored curved hourglass in combination with a cylindrical or conic through hole. The spacer may comprise a reverse hourglass through hole. The spacer may comprise a bulged out barrel form. The spacer may comprise a lateral surface shaped as a double stepped cylinder having a larger outer diameter at its ends compared to a central section.

According to a further aspect of the invention, a bolt assembly is provided, the bolt assembly comprising a bolt, a nut and a spacer. The bolt extends in a longitudinal direction through a flange connection, wherein the bolt comprises a first portion and a second portion, the first portion comprising a threaded section at a first side of the flange connection and the second portion comprising a head portion at a second side of the flange connection. The nut is screwed on the threaded section. The spacer is arranged between the nut and the flange connection or between the head and the flange connection. It is provided that the spacer is shaped to have a lower stiffness in the longitudinal direction under compression compared to the stiffness of a strictly cylindrical shape.

Such aspect of the invention is thus based on the idea to reduce the stiffness of the spacer by giving the spacer a shape different from a cylindrical shape. By providing a lower stiffness of the spacer, the spacer is able to compress more in case of a load and spring back more when the bolt lengthens, thereby improving the integrity of the bolt assembly. Improving the spring action capabilities of the spacer takes away load from the bolts.

In a still further aspect of the invention, a fan case of a gas turbine engine is provided, the fan case comprising a front flange and an aft flange, wherein at least one of the front flange and the aft flange are mounted using a bolt assembly in accordance with the present invention.

In a further aspect of the invention a gas turbine engine for an aircraft is provided which comprises:
an engine core comprising a turbine, a compressor, and a core shaft connecting the turbine to the compressor;
a fan located upstream of the engine core, the fan comprising a plurality of fan blades;
a planetary gearbox that receives an input from the core shaft and outputs drive to the fan so as to drive the fan at a lower rotational speed than the core shaft; and
a fan case implementing at least one bolt assembly in accordance with the present invention, wherein the fan is enclosed by the fan case assembly.

In an embodiment, it is provided that
the turbine is a first turbine, the compressor is a first compressor, and the core shaft is a first core shaft;
the engine core further comprises a second turbine, a second compressor, and a second core shaft connecting the second turbine to the second compressor; and
the second turbine, second compressor, and second core shaft are arranged to rotate at a higher rotational speed than the first core shaft.

It should be noted that the present invention is described in terms of a cylindrical coordinate system having the coordinates x, r and φ. Here x indicates the axial direction, r the radial direction and φ the angle in the circumferential direction. The axial direction is defined by the machine axis of the gas turbine engine in which the present invention is implemented, with the axial direction pointing from the engine inlet to the engine outlet. Starting from the x-axis, the radial direction points radially outwards. Terms such as “in front of”, “forward”, “behind”, “rearward” and “aft” refer to the axial direction or flow direction in the engine. Terms such as “outer” or “inner” refer to the radial direction.

As noted elsewhere herein, the present disclosure may relate to a gas turbine engine. Such a gas turbine engine may comprise an engine core comprising a turbine, a combustor, a compressor, and a core shaft connecting the turbine to the compressor. Such a gas turbine engine may comprise a fan (having fan blades) located upstream of the engine core.

Arrangements of the present disclosure may be particularly, although not exclusively, beneficial for fans that are driven via a gearbox. Accordingly, the gas turbine engine may comprise a gearbox that receives an input from the core shaft and outputs drive to the fan so as to drive the fan at a lower rotational speed than the core shaft. The input to the gearbox may be directly from the core shaft, or indirectly from the core shaft, for example via a spur shaft and/or gear. The core shaft may rigidly connect the turbine and the compressor, such that the turbine and compressor rotate at the same speed (with the fan rotating at a lower speed).

The gas turbine engine as described and/or claimed herein may have any suitable general architecture. For example, the gas turbine engine may have any desired number of shafts that connect turbines and compressors, for example one, two or three shafts. Purely by way of example, the turbine connected to the core shaft may be a first turbine, the compressor connected to the core shaft may be a first compressor, and the core shaft may be a first core shaft. The engine core may further comprise a second turbine, a second compressor, and a second core shaft connecting the second turbine to the second compressor. The second turbine, second compressor, and second core shaft may be arranged to rotate at a higher rotational speed than the first core shaft.

In such an arrangement, the second compressor may be positioned axially downstream of the first compressor. The second compressor may be arranged to receive (for example directly receive, for example via a generally annular duct) flow from the first compressor.

The gearbox may be arranged to be driven by the core shaft that is configured to rotate (for example in use) at the lowest rotational speed (for example the first core shaft in the example above). For example, the gearbox may be arranged to be driven only by the core shaft that is configured to rotate (for example in use) at the lowest rotational speed (for example only be the first core shaft, and not the second core shaft, in the example above). Alternatively, the gearbox may be arranged to be driven by any one or more shafts, for example the first and/or second shafts in the example above.

In any gas turbine engine as described and/or claimed herein, a combustor may be provided axially downstream of the fan and compressor(s). For example, the combustor may be directly downstream of (for example at the exit of) the second compressor, where a second compressor is provided. By way of further example, the flow at the exit to the combustor may be provided to the inlet of the second turbine, where a second turbine is provided. The combustor may be provided upstream of the turbine(s).

The or each compressor (for example the first compressor and second compressor as described above) may comprise any number of stages, for example multiple stages. Each stage may comprise a row of rotor blades and a row of stator vanes, which may be variable stator vanes (in that their angle of incidence may be variable). The row of rotor blades and the row of stator vanes may be axially offset from each other.

The or each turbine (for example the first turbine and second turbine as described above) may comprise any number of stages, for example multiple stages. Each stage may comprise a row of rotor blades and a row of stator vanes. The row of rotor blades and the row of stator vanes may be axially offset from each other.

Each fan blade may be defined as having a radial span extending from a root (or hub) at a radially inner gas-washed location, or 0% span position, to a tip at a 100% span position. The ratio of the radius of the fan blade at the hub to the radius of the fan blade at the tip may be less than (or on the order of) any of: 0.4, 0.39, 0.38 0.37, 0.36, 0.35, 0.34, 0.33, 0.32, 0.31, 0.3, 0.29, 0.28, 0.27, 0.26, or 0.25. The ratio of the radius of the fan blade at the hub to the radius of the fan blade at the tip may be in an inclusive range bounded by any two of the values in the previous sentence (i.e. the values may form upper or lower bounds). These ratios may commonly be referred to as the hub-to-tip ratio. The radius at the hub and the radius at the tip may both be measured at the leading edge (or axially forwardmost) part of the blade. The hub-to-tip ratio refers, of course, to the gas-washed portion of the fan blade, i.e. the portion radially outside any platform.

The radius of the fan may be measured between the engine centreline and the tip of a fan blade at its leading edge. The fan diameter (which may simply be twice the radius of the fan) may be greater than (or on the order of) any of: 250 cm (around 100 inches), 260 cm, 270 cm (around 105 inches), 280 cm (around 110 inches), 290 cm (around 115 inches), 300 cm (around 120 inches), 310 cm, 320 cm (around 125 inches), 330 cm (around 130 inches), 340 cm (around 135 inches), 350cm, 360cm (around 140 inches), 370 cm (around 145 inches), 380 (around 150 inches) cm or 390 cm (around 155 inches). The fan diameter may be in an inclusive range bounded by any two of the values in the previous sentence (i.e. the values may form upper or lower bounds).

The rotational speed of the fan may vary in use. Generally, the rotational speed is lower for fans with a higher diameter. Purely by way of non-limitative example, the rotational speed of the fan at cruise conditions may be less than 2500 rpm, for example less than 2300 rpm. Purely by way of further non-limitative example, the rotational speed of the fan at cruise conditions for an engine having a fan diameter in the range of from 250 cm to 300 cm (for example 250 cm to 280 cm) may be in the range of from 1700 rpm to 2500 rpm, for example in the range of from 1800 rpm to 2300 rpm, for example in the range of from 1900 rpm to 2100 rpm. Purely by way of further non-limitative example, the rotational speed of the fan at cruise conditions for an engine having a fan diameter in the range of from 320 cm to 380 cm may be in the range of from 1200 rpm to 2000 rpm, for example in the range of from 1300 rpm to 1800 rpm, for example in the range of from 1400 rpm to 1600 rpm.

In use of the gas turbine engine, the fan (with associated fan blades) rotates about a rotational axis. This rotation results in the tip of the fan blade moving with a velocity Utip. The work done by the fan blades 13 on the flow results in an enthalpy rise dH of the flow. A fan tip loading may be defined as dH/Utip2, where dH is the enthalpy rise (for example the 1-D average enthalpy rise) across the fan and Utip is the (translational) velocity of the fan tip, for example at the leading edge of the tip (which may be defined as fan tip radius at leading edge multiplied by angular speed). The fan tip loading at cruise conditions may be greater than (or on the order of) any of: 0.3, 0.31, 0.32, 0.33, 0.34, 0.35, 0.36, 0.37, 0.38, 0.39 or 0.4 (all units in this paragraph being Jkg-1 K-1/(ms−1)2). The fan tip loading may be in an inclusive range bounded by any two of the values in the previous sentence (i.e. the values may form upper or lower bounds).

Gas turbine engines in accordance with the present disclosure may have any desired bypass ratio, where the bypass ratio is defined as the ratio of the mass flow rate of the flow through the bypass duct to the mass flow rate of the flow through the core at cruise conditions. In some arrangements the bypass ratio may be greater than (or on the order of) any of the following: 10, 10.5, 11, 11.5, 12, 12.5, 13, 13.5, 14, 14.5, 15, 15.5, 16, 16.5, or 17. The bypass ratio may be in an inclusive range bounded by any two of the values in the previous sentence (i.e. the values may form upper or lower bounds). The bypass duct may be substantially annular. The bypass duct may be radially outside the core engine. The radially outer surface of the bypass duct may be defined by a nacelle and/or a fan case.

The overall pressure ratio of a gas turbine engine as described and/or claimed herein may be defined as the ratio of the stagnation pressure upstream of the fan to the stagnation pressure at the exit of the highest pressure compressor (before entry into the combustor). By way of non-limitative example, the overall pressure ratio of a gas turbine engine as described and/or claimed herein at cruise may be greater than (or on the order of) any of the following: 35, 40, 45, 50, 55, 60, 65, 70, 75. The overall pressure ratio may be in an inclusive range bounded by any two of the values in the previous sentence (i.e. the values may form upper or lower bounds).

Specific thrust of an engine may be defined as the net thrust of the engine divided by the total mass flow through the engine. At cruise conditions, the specific thrust of an engine described and/or claimed herein may be less than (or on the order of) any of the following: 110 Nkg-1s, 105 Nkg-1s, 100 Nkg-1s, 95 Nkg-1s, 90 Nkg-1s, 85 Nkg-1s or 80 Nkg-1s. The specific thrust may be in an inclusive range bounded by any two of the values in the previous sentence (i.e. the values may form upper or lower bounds). Such engines may be particularly efficient in comparison with conventional gas turbine engines.

A gas turbine engine as described and/or claimed herein may have any desired maximum thrust. Purely by way of non-limitative example, a gas turbine as described and/or claimed herein may be capable of producing a maximum thrust of at least (or on the order of) any of the following: 160 kN, 170 kN, 180 kN, 190 kN, 200 kN, 250 kN, 300 kN, 350 kN, 400 kN, 450 kN, 500 kN, or 550 kN. The maximum thrust may be in an inclusive range bounded by any two of the values in the previous sentence (i.e. the values may form upper or lower bounds). The thrust referred to above may be the maximum net thrust at standard atmospheric conditions at sea level plus 15 deg C. (ambient pressure 101.3kPa, temperature 30 deg C.), with the engine static.

In use, the temperature of the flow at the entry to the high pressure turbine may be particularly high. This temperature, which may be referred to as TET, may be measured at the exit to the combustor, for example immediately upstream of the first turbine vane, which itself may be referred to as a nozzle guide vane. At cruise, the TET may be at least (or on the order of) any of the following: 1400K, 1450K, 1500K, 1550K, 1600K or 1650K. The TET at cruise may be in an inclusive range bounded by any two of the values in the previous sentence (i.e. the values may form upper or lower bounds). The maximum TET in use of the engine may be, for example, at least (or on the order of) any of the following: 1700K, 1750K, 1800K, 1850K, 1900K, 1950K or 2000K. The maximum TET may be in an inclusive range bounded by any two of the values in the previous sentence (i.e. the values may form upper or lower bounds). The maximum TET may occur, for example, at a high thrust condition, for example at a maximum take-off (MTO) condition.

A fan blade and/or aerofoil portion of a fan blade described and/or claimed herein may be manufactured from any suitable material or combination of materials. For example, at least a part of the fan blade and/or aerofoil may be manufactured at least in part from a composite, for example a metal matrix composite and/or an organic matrix composite, such as carbon fiber. By way of further example at least a part of the fan blade and/or aerofoil may be manufactured at least in part from a metal, such as a titanium based metal or an aluminum based material (such as an aluminum-lithium alloy) or a steel based material. The fan blade may comprise at least two regions manufactured using different materials. For example, the fan blade may have a protective leading edge, which may be manufactured using a material that is better able to resist impact (for example from birds, ice or other material) than the rest of the blade. Such a leading edge may, for example, be manufactured using titanium or a titanium-based alloy. Thus, purely by way of example, the fan blade may have a carbon-fiber or aluminum based body (such as an aluminum lithium alloy) with a titanium leading edge.

A fan as described and/or claimed herein may comprise a central portion, from which the fan blades may extend, for example in a radial direction. The fan blades may be attached to the central portion in any desired manner. For example, each fan blade may comprise a fixture which may engage a corresponding slot in the hub (or disc). Purely by way of example, such a fixture may be in the form of a dovetail that may slot into and/or engage a corresponding slot in the hub/disc in order to fix the fan blade to the hub/disc. By way of further example, the fan blades maybe formed integrally with a central portion. Such an arrangement may be referred to as a blisk or a bling. Any suitable method may be used to manufacture such a blisk or bling. For example, at least a part of the fan blades may be machined from a block and/or at least part of the fan blades may be attached to the hub/disc by welding, such as linear friction welding.

The gas turbine engines described and/or claimed herein may or may not be provided with a variable area nozzle (VAN). Such a variable area nozzle may allow the exit area of the bypass duct to be varied in use. The general principles of the present disclosure may apply to engines with or without a VAN.

The fan of a gas turbine as described and/or claimed herein may have any desired number of fan blades, for example 16, 18, 20, or 22 fan blades.

As used herein, cruise conditions may mean cruise conditions of an aircraft to which the gas turbine engine is attached. Such cruise conditions may be conventionally defined as the conditions at mid-cruise, for example the conditions experienced by the aircraft and/or engine at the midpoint (in terms of time and/or distance) between top of climb and start of decent.

Purely by way of example, the forward speed at the cruise condition may be any point in the range of from Mach 0.7 to 0.9, for example 0.75 to 0.85, for example 0.76 to 0.84, for example 0.77 to 0.83, for example 0.78 to 0.82, for example 0.79 to 0.81, for example on the order of Mach 0.8, on the order of Mach 0.85 or in the range of from 0.8 to 0.85. Any single speed within these ranges may be the cruise condition. For some aircraft, the cruise conditions may be outside these ranges, for example below Mach 0.7 or above Mach 0.9.

Purely by way of example, the cruise conditions may correspond to standard atmospheric conditions at an altitude that is in the range of from 10000 m to 15000 m, for example in the range of from 10000 m to 12000 m, for example in the range of from 10400 m to 11600 m (around 38000 ft), for example in the range of from 10500 m to 11500 m, for example in the range of from 10600 m to 11400 m, for example in the range of from 10700 m (around 35000 ft) to 11300 m, for example in the range of from 10800 m to 11200 m, for example in the range of from 10900 m to 11100 m, for example on the order of 11000 m. The cruise conditions may correspond to standard atmospheric conditions at any given altitude in these ranges.

Purely by way of example, the cruise conditions may correspond to: a forward Mach number of 0.8; a pressure of 23000 Pa; and a temperature of −55 deg C.

As used anywhere herein, “cruise” or “cruise conditions” may mean the aerodynamic design point. Such an aerodynamic design point (or ADP) may correspond to the conditions (comprising, for example, one or more of the Mach Number, environmental conditions and thrust requirement) for which the fan is designed to operate. This may mean, for example, the conditions at which the fan (or gas turbine engine) is designed to have optimum efficiency.

In use, a gas turbine engine described and/or claimed herein may operate at the cruise conditions defined elsewhere herein. Such cruise conditions may be determined by the cruise conditions (for example the mid-cruise conditions) of an aircraft to which at least one (for example 2 or 4) gas turbine engine may be mounted in order to provide propulsive thrust.

The skilled person will appreciate that except where mutually exclusive, a feature or parameter described in relation to any one of the above aspects may be applied to any other aspect. Furthermore, except where mutually exclusive, any feature or parameter described herein may be applied to any aspect and/or combined with any other feature or parameter described herein.

The invention will be explained in more detail on the basis of exemplary embodiments with reference to the accompanying drawings in which:

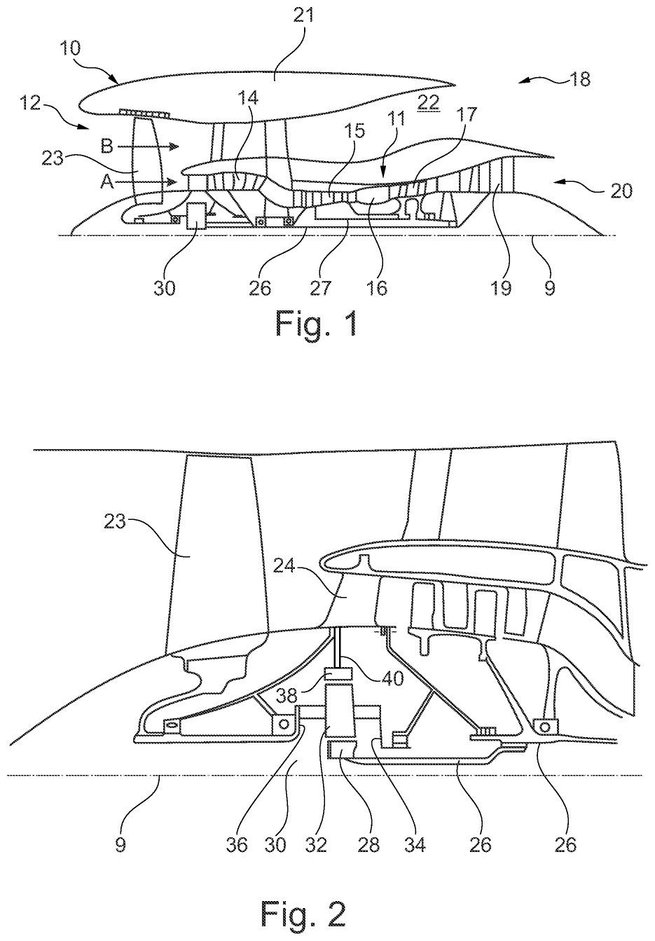

FIG. 1 is a sectional side view of a gas turbine engine;

FIG. 2 is a close up sectional side view of an upstream portion of a gas turbine engine;

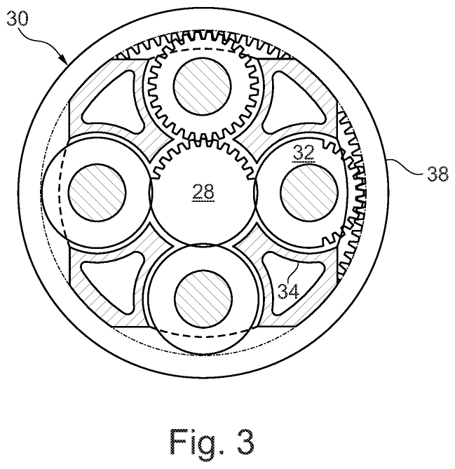

FIG. 3 is a partially cut-away view of a gearbox for a gas turbine engine;

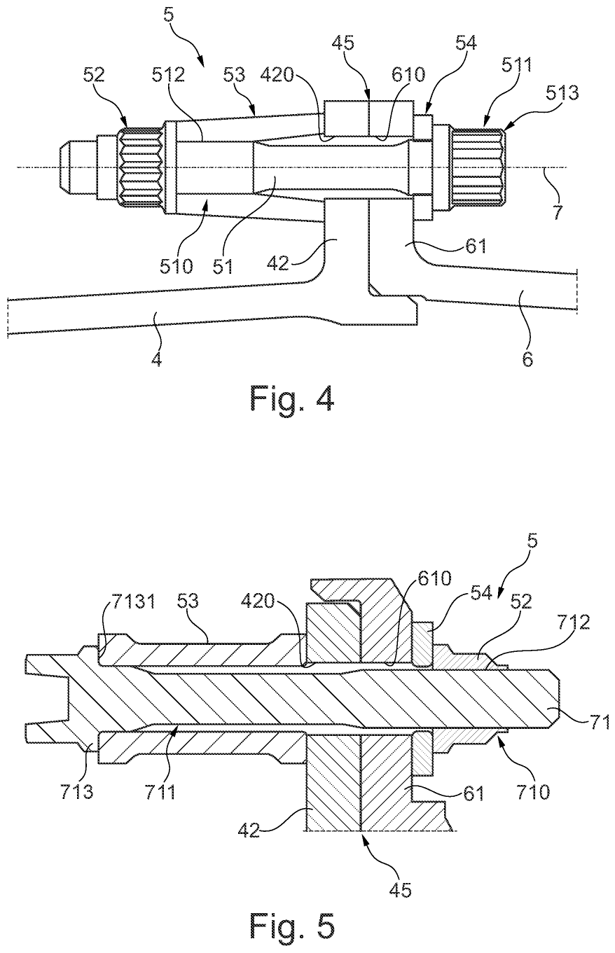

FIG. 4 is an embodiment of a bolt assembly comprising a bolt and a spacer, wherein the bolt is comprised of a titanium alloy;

FIG. 5 is a further embodiment of a bolt assembly comprising a bolt and a spacer, wherein the bolt is comprised of a titanium alloy;

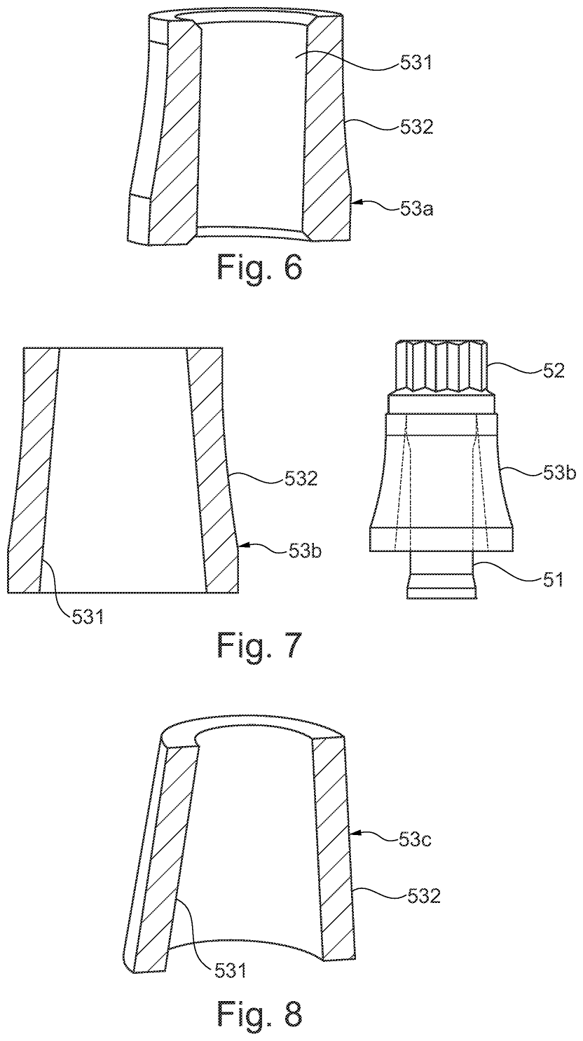

FIGS. 6-14 depict sectional or perspective views of different embodiments of a spacer that may be implemented in the bolt assemblies of FIGS. 4 and 5; and

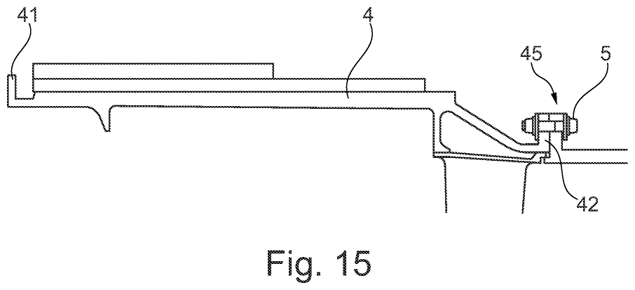

FIG. 15 a fan case having a front flange and an aft flange.

FIG. 1 illustrates a gas turbine engine 10 having a principal rotational axis 9. The engine 10 comprises an air intake 12 and a propulsive fan 23 that generates two airflows: a core airflow A and a bypass airflow B. The gas turbine engine 10 comprises a core 11 that receives the core airflow A. The engine core 11 comprises, in axial flow series, a low pressure compressor 14, a high-pressure compressor 15, combustion equipment 16, a high-pressure turbine 17, a low pressure turbine 19 and a core exhaust nozzle 20. A nacelle 21 surrounds the gas turbine engine 10 and defines a bypass duct 22 and a bypass exhaust nozzle 18. The bypass airflow B flows through the bypass duct 22. The fan 23 is attached to and driven by the low pressure turbine 19 via a shaft 26 and an epicyclical gearbox 30.

In use, the core airflow A is accelerated and compressed by the low pressure compressor 14 and directed into the high pressure compressor 15 where further compression takes place. The compressed air exhausted from the high pressure compressor 15 is directed into the combustion equipment 16 where it is mixed with fuel and the mixture is combusted. The resultant hot combustion products then expand through, and thereby drive, the high pressure and low pressure turbines 17, 19 before being exhausted through the nozzle 20 to provide some propulsive thrust. The high pressure turbine 17 drives the high pressure compressor 15 by a suitable interconnecting shaft 27. The fan 23 generally provides the majority of the propulsive thrust. The epicyclical gearbox 30 is a reduction gearbox.

An exemplary arrangement for a geared fan gas turbine engine 10 is shown in FIG. 2. The low pressure turbine 19 (see FIG. 1) drives the shaft 26, which is coupled to a sun wheel, or sun gear, 28 of the epicyclical gear arrangement 30. Radially outwardly of the sun gear 28 and intermeshing therewith is a plurality of planet gears 32 that are coupled together by a planet carrier 34. The planet carrier 34 constrains the planet gears 32 to process around the sun gear 28 in synchronicity whilst enabling each planet gear 32 to rotate about its own axis. The planet carrier 34 is coupled via linkages 36 to the fan 23 in order to drive its rotation about the engine axis 9. Radially outwardly of the planet gears 32 and intermeshing therewith is an annulus or ring gear 38 that is coupled, via linkages 40, to a stationary supporting structure 24.

Note that the terms “low pressure turbine” and “low pressure compressor” as used herein may be taken to mean the lowest pressure turbine stages and lowest pressure compressor stages (i.e. not including the fan 23) respectively and/or the turbine and compressor stages that are connected together by the interconnecting shaft 26 with the lowest rotational speed in the engine (i.e. not including the gearbox output shaft that drives the fan 23). In some literature, the “low pressure turbine” and “low pressure compressor” referred to herein may alternatively be known as the “intermediate pressure turbine” and “intermediate pressure compressor”. Where such alternative nomenclature is used, the fan 23 may be referred to as a first, or lowest pressure, compression stage.

The epicyclical gearbox 30 is shown by way of example in greater detail in FIG. 3. Each of the sun gear 28, planet gears 32 and ring gear 38 comprise teeth about their periphery to intermesh with the other gears. However, for clarity only exemplary portions of the teeth are illustrated in FIG. 3. There are four planet gears 32 illustrated, although it will be apparent to the skilled reader that more or fewer planet gears 32 may be provided within the scope of the claimed invention. Practical applications of a planetary epicyclical gearbox 30 generally comprise at least three planet gears 32.

The epicyclical gearbox 30 illustrated by way of example in FIGS. 2 and 3 is of the planetary type, in that the planet carrier 34 is coupled to an output shaft via linkages 36, with the ring gear 38 fixed. However, any other suitable type of epicyclical gearbox 30 may be used. By way of further example, the epicyclical gearbox 30 may be a star arrangement, in which the planet carrier 34 is held fixed, with the ring (or annulus) gear 38 allowed to rotate. In such an arrangement the fan 23 is driven by the ring gear 38. By way of further alternative example, the gearbox 30 may be a differential gearbox in which the ring gear 38 and the planet carrier 34 are both allowed to rotate.

It will be appreciated that the arrangement shown in FIGS. 2 and 3 is by way of example only, and various alternatives are within the scope of the present disclosure. Purely by way of example, any suitable arrangement may be used for locating the gearbox 30 in the engine 10 and/or for connecting the gearbox 30 to the engine 10. By way of further example, the connections (such as the linkages 36, 40 in the FIG. 2 example) between the gearbox 30 and other parts of the engine 10 (such as the input shaft 26, the output shaft and the fixed structure 24) may have any desired degree of stiffness or flexibility. By way of further example, any suitable arrangement of the bearings between rotating and stationary parts of the engine (for example between the input and output shafts from the gearbox and the fixed structures, such as the gearbox casing) may be used, and the disclosure is not limited to the exemplary arrangement of FIG. 2. For example, where the gearbox 30 has a star arrangement (described above), the skilled person would readily understand that the arrangement of output and support linkages and bearing locations would typically be different to that shown by way of example in FIG. 2.

Accordingly, the present disclosure extends to a gas turbine engine having any arrangement of gearbox styles (for example star or planetary), support structures, input and output shaft arrangement, and bearing locations.

Optionally, the gearbox may drive additional and/or alternative components (e.g. the intermediate pressure compressor and/or a booster compressor).

Other gas turbine engines to which the present disclosure may be applied may have alternative configurations. For example, such engines may have an alternative number of compressors and/or turbines and/or an alternative number of interconnecting shafts. By way of further example, the gas turbine engine shown in FIG. 1 has a split flow nozzle 20, 22 meaning that the flow through the bypass duct 22 has its own nozzle that is separate to and radially outside the core engine nozzle 20. However, this is not limiting, and any aspect of the present disclosure may also apply to engines in which the flow through the bypass duct 22 and the flow through the core 11 are mixed, or combined, before (or upstream of) a single nozzle, which may be referred to as a mixed flow nozzle. One or both nozzles (whether mixed or split flow) may have a fixed or variable area. Whilst the described example relates to a turbofan engine, the disclosure may apply, for example, to any type of gas turbine engine, such as an open rotor (in which the fan stage is not surrounded by a nacelle) or turboprop engine, for example. In some arrangements, the gas turbine engine 10 may not comprise a gearbox 30.

The geometry of the gas turbine engine 10, and components thereof, is defined by a conventional axis system, comprising an axial direction (which is aligned with the rotational axis 9), a radial direction (in the bottom-to-top direction in FIG. 1), and a circumferential direction (perpendicular to the page in the FIG. 1 view). The axial, radial and circumferential directions are mutually perpendicular.

In the context of the present invention, the design of bolt assemblies used to connect a fan case with adjacent structures is of relevance. The fan case in the context of which the bolt assemblies are implemented may be the fan case of a geared turbofan engine as discussed with respect to FIGS. 1 to 3 or may generally be the fan case of any gas turbine engine. More particularly, a particularly useful application lies with bolt assemblies of fan cases of Civil Small and Medium Engines, which may have a fan diameter in the range between 35 to 55″. However, the principles of the present invention are not dependent on a particular kind of gas turbine engine or flange connection location.

To better understand the context in which the present invention may be implemented, the general design of a fan case is initially discussed with respect to FIG. 15. FIG. 15 depicts an embodiment of a fan case 4 circumferentially surrounding a fan. The fan case 4 comprises a front end flange 41 at which it is connected to an engine inlet (not shown), wherein the connection is realized by means of a front flange connection. The front flange connection is also referred to as an A1 connection. The fan case 4 further comprises an aft end flange 42 at which it is connected to further structural elements of the gas turbine engine. The connection is by means of an aft flange connection 45 which is also referred to as A3 connection. The aft flange connection 45 comprises a bolt assembly 5, embodiments of which be discussed with respect to FIGS. 1 to 14. A similar bolt assembly may be implemented at the front flange connection. Several liners or panels may be arranged along an inner surface of the fan case 4 (not shown).

The bolt assembly 5 is configured to withstand an FBO event and maintain the integrity of the bolt assembly 5 in case of an FBO event.

FIG. 4 depicts an embodiment of a bolt assembly 5 as may be implemented with an A3 connection or an A1 connection of a fan case 4 as depicted in FIG. 15. The bolt assembly 5 comprises a bolt 51, a nut 52 and a spacer 53. The bolt assembly 5 connects an aft flange 42 of a fan case 4 and a front flange 61 of a further structure 6 to provide for a flange connection 45. The further structure 6 may be outlet guide vane mount ring, for example.

The bolt 51 generally extends in a longitudinal direction 7 through holes 420, 610 in flanges 42, 61. The assembled bolt 51 comprises a first portion 510 located on a first (in FIG. 4 left) side of the flange connection 45. It further comprises a second portion 511 located on a second (in FIG. 4 right) side of the flange connection 45. The first portion 510 comprises a threaded section 512 onto which the nut 52 is screwed. The spacer 53 is arranged and extends between the nut 52 and the flange 42. The second portion 511 comprises a head portion 513 which rests against the flange 61 through a washer 54.

The spacer 53 has a generally conic shape, increasing in inner diameter and outer diameter in the longitudinal direction 7, thereby having a reduced stiffness and increased flexibility in the longitudinal direction under compression. Other embodiments of the spacer 53 are discussed with respect to FIGS. 6 to 14.

By applying a torque on nut 52, the bolt assembly 5 is tightened, wherein a force is exercised by head portion 513 and washer 54 against the axial direction on flange 61 and a force is exercised by spacer 53 in the axial direction on flange 42. Accordingly, the spacer 53 is compressed to some extent depending on the applied torque.

The bolt 51 is comprised of a titanium alloy which has a yield strength above 500 MPa, an elastic modulus smaller than 150 GPa, a density smaller than 5 g/cc, and an elongation at failure larger than 15 percent. The spacer 53 may be comprised of a Ti-3Al-8V-6Cr-4Mo-4Zr titanium alloy, known as Ti Beta-C. Alternatively, the spacer 53 is made out of steel. The nut 52 and the washer 54 may be made out of steel, such as A286.

Further, the fan case 4 with flange 42 may be made out of a titanium alloy or made out of steel. The first structure 6 with flange 61 may also be made out of a titanium alloy or made out of steel.

By forming bolt 51 out of a titanium alloy, the bolt 51 is exposed to less load in an FBO event as the elastic modulus of titanium alloys is relatively low compared to bolts made out of steel or superalloys. At the same time, the spacer provides for an increased flexibility due to its shape and/or material (such as Ti Beta-C) such that it can compress more for a given load compared to a strictly cylindrical design. This “springier” spacer design further reduces the load taken by the bolt 51 in case of an FBO event. It further improves the ability of the bolt assembly 5 to return to its original shape after an FBO event and make up for potentially slightly plastically deformed bolts after an FBO event.

FIG. 5 shows an alternative embodiment of a bolt assembly 5 which also comprises a bolt 71, a nut 52, a spacer 53 and a washer 54. The materials used for these elements are the same as discussed with respect to FIG. 4.

The difference to the embodiment of FIG. 4 lies in the arrangement of the elements. In FIG. 5, the bolt 71 generally extends in a longitudinal direction through holes 420, 610 in flanges 42, 61. The assembled bolt 71 comprises a first portion 710 located on a first (in FIG. 5 right) side of the flange connection 45. It further comprises a second portion 711 located on a second (in FIG. 5 left) side of the flange connection 45. The first portion 710 comprises a threaded section 712 onto which the nut 52 is screwed. The nut 52 rests against flange 61 through washer 54. The second portion 711 comprises a head portion 713. The spacer 53 is arranged and extends between a face 7131 of the head portion 713 and flange 42.

In FIG. 5, the spacer 53 has a cylindrical design. However, in other embodiments, a more flexible design such as the design of FIG. 4 is implemented, wherein a more flexible design reduces the load on bolt 51 in case of an FBO event.

Except for the spacer design, the difference between the embodiments of FIGS. 4 and 5 lies in the arrangement of the spacer 53 between the nut 52 and the flange connection 45 or between the head portion 713 and the flange connection 45. In the context of the present invention, it is pointed out that both designs may be used to implement the particular materials of the bolt assembly 5 as discussed with respect to FIG. 4.

FIGS. 6 to 14 show embodiments of a further optimized spacer 53 which is given a design which makes it springier in nature compared to a strictly cylindrical design as shown in FIG. 5. The increased flexibility/reduced stiffness in the longitudinal direction is provided for by the shape of the spacer 53. In additional flexibility may be provided for by the discussed titanium alloy materials which have generally a low elastic modulus. The discussed designs allow the spacer to compress more under the same load by modifying the expansion of the spacer 53 perpendicular to direction of loading (which is the longitudinal direction).

In FIG. 6, a spacer 53a is provided which comprises a conic shaped lateral surface 532. A through hole 531 of the spacer 53a is cylindrical.

In FIG. 7, a spacer 53b is provided which has a lateral surface 532 which is curved and comprises cylindrical sections. In this embodiment, the through hole 531 is conic. FIG. 7 also includes a perspective depiction of spacer 53b that further includes the nut 52 and the bolt 51 of FIG. 4.

FIG. 8 is a combination of the embodiments of FIGS. 6 and 7, wherein both the lateral surface 532 and the through hole 531 are conic.

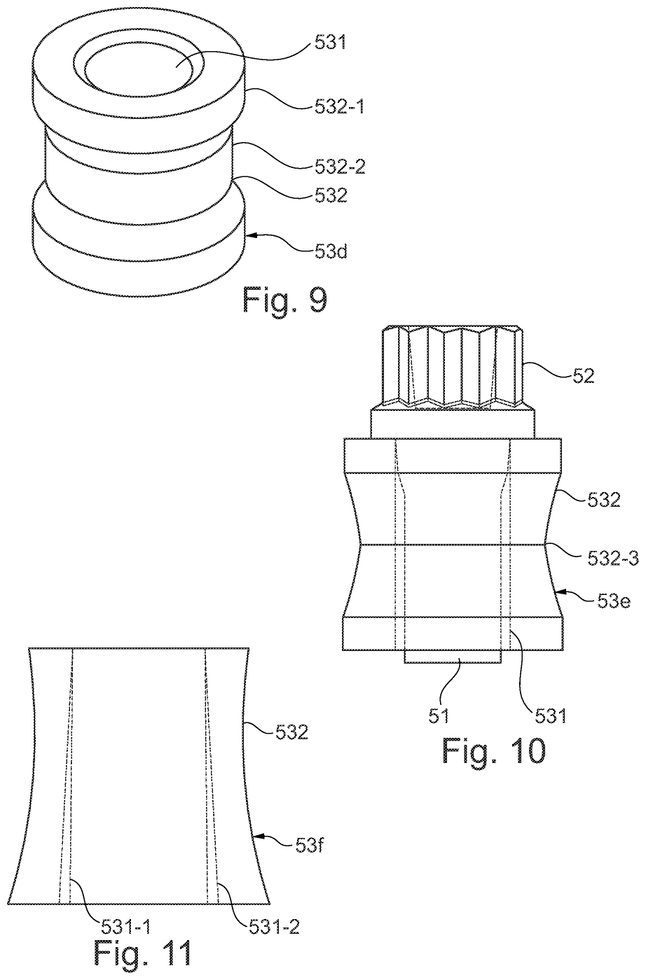

In FIG. 9, a spacer 53d is provided which comprises a cylindrical through hole 531. The lateral surface 531 is shaped as a double step cylinder having a larger outer diameter at its ends 532-1 and a smaller diameter in a central section 532-2.

In FIG. 10, a spacer 53e is provided with a lateral surface 532 which is formed as a conic hourglass, wherein a minimal outer diameter 532-3 is formed in the axial center of the spacer 53e. The through hole 531 is formed as a cylindrical through hole.

In FIG. 11, a spacer 53f is provided which comprises a lateral surface 532 which is formed as a curved hourglass, wherein the through hole 531 is a cylindrical/straight through hole 531-1 or a conic through hole 531-2.

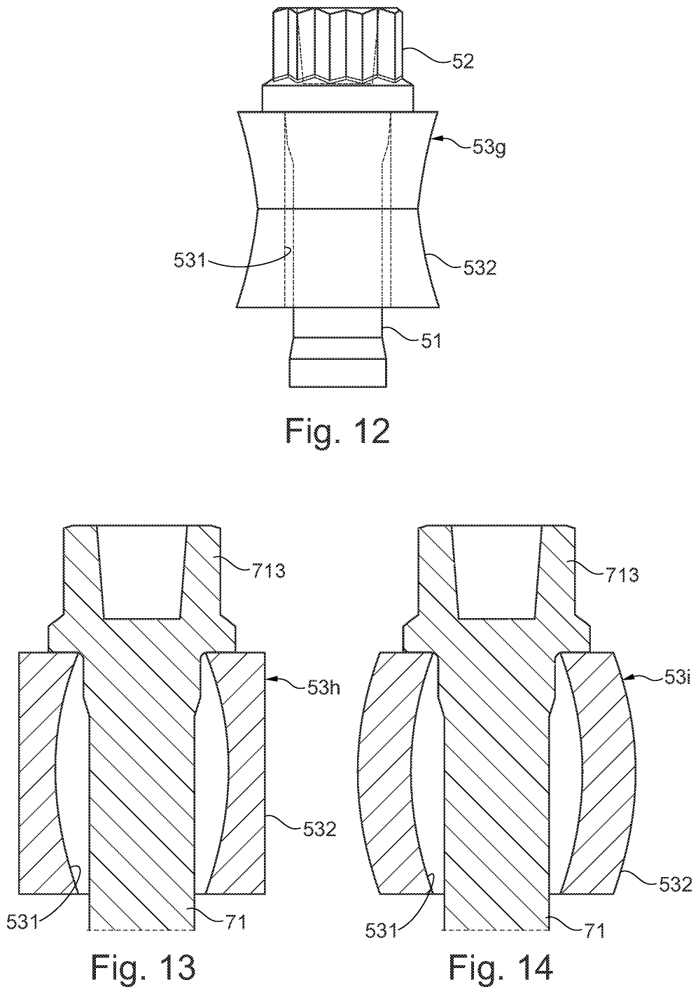

In FIG. 12, a spacer 53g is provided which comprises a lateral surface 532 which is formed as a mirrored curved hourglass, wherein the through hole 531 is a cylindrical through hole.

In FIG. 13, a spacer 53h is provided which comprises a through hole 531 formed as a reverse hourglass and thus comprising the minimal inner diameter at the longitudinal ends of the spacer 53h. The lateral surface 532 is cylindrical.

In FIG. 14, a spacer 53i is provided which comprises a through hole 531 formed as a reverse hourglass and thus comprising the minimal inner diameter at the longitudinal ends of the spacer 53i. The lateral surface 532 is also formed as a reverse hourglass thus comprising the minimal outer diameter also at the longitudinal ends of the spacer 54i. These shapes of the through hole 531 and of the lateral surface 532 together lead to an overall shape of the spacer 53i in the form of a double hourglass or bulged barrel.

All the above discussed designs provide for a reduced stiffness in compression while avoiding buckling and maintaining elastic spring-back to preserve bolt integrity.

It should be understood that the above description is intended for illustrative purposes only and is not intended to limit the scope of the present disclosure in any way. Also, those skilled in the art will appreciate that other aspects of the disclosure can be obtained from a study of the drawings, the disclosure and the appended claims. All methods described herein can be performed in any suitable order unless otherwise indicated herein or otherwise clearly contradicted by context. Various features of the various embodiments disclosed herein can be combined in different combinations to create new embodiments within the scope of the present disclosure. In particular, the disclosure extends to and includes all combinations and sub-combinations of one or more features described herein. Any ranges given herein include any and all specific values within the range and any and all sub-ranges within the given range.

1. A bolt assembly comprising:
a bolt extending in a longitudinal direction through a flange connection, the bolt comprising a first portion and a second portion, the first portion comprising a threaded section at a first side of the flange connection, the second portion comprising a head portion at a second side of the flange connection;
a nut screwed on the threaded section; and
a spacer arranged between the nut and the flange connection or between the head portion and the flange connection;
wherein the bolt is comprised of a titanium alloy.

2. The bolt assembly of claim 1, wherein the bolt titanium alloy has at least one of a yield strength above 500 MPa, an elastic modulus smaller than 150 GPa, a density smaller than 5 g/cc and an elongation at failure larger than 15 percent.

3. The bolt assembly of claim 1, wherein the bolt titanium alloy has an elongation at failure larger than 15 percent.

4. The bolt assembly of claim 1, wherein in addition the spacer is comprised of a titanium alloy.

5. The bolt assembly of claim 4, wherein the spacer titanium alloy has a larger elasticity than the bolt titanium alloy.

6. The bolt assembly of claim 5, wherein the spacer is comprised of a Ti-3Al-8V-6Cr-4Mo-4Zr titanium alloy.

7. The bolt assembly of claim 1, wherein the spacer is shaped to have a lower stiffness in the longitudinal direction under compression compared to the stiffness of a strictly cylindrical shape.

8. The bolt assembly of claim 7, wherein the spacer comprises a conic shaped lateral surface.

9. The bolt assembly of claim 7, wherein the spacer comprises a conic through hole.

10. The bolt assembly of claim 7, wherein the spacer comprises a lateral surface shaped as a conic hourglass, a curved hourglass or a mirrored curved hourglass.

11. The bolt assembly of claim 10, wherein the spacer comprises a cylindrical or conic through hole.

12. The bolt assembly of claim 7, wherein the spacer comprises a reverse hourglass through hole.

13. The bolt assembly of claim 7, wherein the spacer comprises a bulged out barrel form.

14. The bolt assembly of claim 7, wherein the spacer comprises a lateral surface shaped as a double stepped cylinder having a larger outer diameter and its ends and a smaller outer diameter in a central section.

15. A bolt assembly comprising:
a bolt extending in a longitudinal direction through a flange connection, the bolt comprising a first portion and a second portion, the first portion comprising a threaded section at a first side of the flange connection, the second portion comprising a head portion at a second side of the flange connection;
a nut screwed on the threaded section; and
a spacer arranged between the nut and the flange connection or between the head portion and the flange connection;
wherein the spacer is shaped to have a lower stiffness in the longitudinal direction under compression compared to the stiffness of a strictly cylindrical shape.

16. The bolt assembly of claim 16, wherein the spacer comprises a conic shaped lateral surface.

17. The bolt assembly of claim 15, wherein the spacer comprises a conic through hole.

18. The bolt assembly of claim 17, wherein the spacer comprises a lateral surface shaped as a conic hourglass, a curved hourglass or a mirrored curved hourglass and further comprises a cylindrical or conic through hole.

19. The bolt assembly of claim 15, wherein the spacer comprises a reverse hourglass through hole or a bulged out barrel form.

20. The bolt assembly of claim 15, wherein the spacer comprises a lateral surface shaped as a double stepped cylinder having a larger outer diameter and its ends and a smaller outer diameter in a central section.
